(19) United States
(12) Patent Application Publication
(10) Pub. No.: US 2025/0264662 A1
(43) Pub. Date: Aug. 21, 2025

(54) OPTICAL COUPLER FOR A LIGHTING SYSTEM, IN PARTICULAR FOR A VEHICLE PASSENGER COMPARTMENT

(71) Applicant: VALEO VISION, Bobigny (FR)

(72) Inventor: Pierre Louis TASSY, Bobigny (FR)

(73) Assignee: VALEO VISION, Bobigny (FR)

(21) Appl. No.: 18/850,199

(22) PCT Filed: Mar. 28, 2023
(86) PCT No.: PCT/EP2023/058063

§ 371 Date: Sep. 24, 2024

(30) Foreign Application Priority Data
Mar. 31, 2022 (FR) 2202973

(51) Int. Cl. G02B 6/26; B60Q 3/54; B60Q 3/64; G02B 6/34

(52) U.S. Cl. CPC G02B 6/262; B60Q 3/54; B60Q 3/64; G02B 6/34

(57) ABSTRACT

The invention relates to an optical coupler having a longitudinal central axis. The optical coupler including a first, a second and a third portion. The first portion has an envelope following the shape of an ellipsoid of revolution of axis, truncated by a plane of section perpendicular to the longitudinal axis, with a polygonal cross section. The third portion has an envelope following the shape of a right prism, of polygonal cross section the area of which cross section is constant between a second intermediate section and a first exit section, the area of the first intermediate section being greater than the area of the second intermediate section. The second portion being a transition portion positioned between the first portion and the third portion, with the second portion having an envelope with a cross section the area of which decreases progressively along the longitudinal axis.

### TECHNICAL FIELD

The technical field of the invention is that of optical coupling.

The present invention relates to an optical coupler and to an optical illumination system, particularly for a vehicle interior.

### BACKGROUND OF THE INVENTION

The interior compartment of a vehicle may comprise a plurality of luminous systems for illuminating and notably for back-lighting, for functional but also esthetic purposes, comprised in trim panels.

Patent EP2145796A2 presents for example an interior trim panel for a motor vehicle provided with a back-lit zone, the panel comprising a rigid support layer, a covering on the support layer defining a visible face of the panel, and a luminous device able to illuminate a zone from the reverse side of the support layer, the support layer and the covering being suitable for allowing the light from the luminous device to pass through so that it is visible on the panel.

A trim panel may for example have luminous colored patterns selected by the user or by the constructor of the vehicle, depending on the nature of the luminous device.

Patent US2016229338A1 presents a trim panel comprising a textile covering, a transparent base and a luminous device comprising a luminous source, of the LED (light-emitting diode) type, for example, and light guides, the luminous source being positioned in front of the light guide. When the light guide is illuminated by the luminous source, colorimetric effects may be obtained as a result of the colors of the filaments of the covering which allows the light to pass through.

Patent US2014211498A1 presents an interior trim panel for a motor vehicle, which comprises: a support layer, which determines the contour of the interior trim panel, a cover layer, which is applied to a front side of the support layer, and a light-emitting layer, which is applied to a rear side of the support layer, and in which the support component and the cover layer are transparent. The light-emitting layer is a fabric into which a bundle of optical fibers are woven, the optical fibers being twisted into a connector to which a luminous source for example may be connected. The bundle of optical fibers is able to guide the light waves, visible on the trim panel, it being possible for the light waves to be of any color selected by the user of the vehicle or by the constructor.

However, when a luminous source of the RGB (red green blue) LED (light-emitting diode) for example is used, it is sometimes difficult to obtain uniform illumination for each color at the entry to each optical fiber, and this results in a non-uniform luminous flux and a non-homogeneous distribution of the colors in each optical fiber.

Patent EP0562873B1 presents an optical coupling device with a constant polygonal cross section used with a high-intensity luminous source, the polygonal cross section making it possible to obtain improved mixing of light and thus uniform illumination for each color at the exit of the coupler. The optical coupler can be used for coupling the luminous source to a bundle of optical fibers, via a connector.

Now, the cross section of an optical-fiber bundle connector is dependent on the number and type of twisted fibers and may be smaller than the surface area of the luminous source at the entry to a coupler, thus rendering the use of a coupler of constant cross section, such as that presented in patent EP0562873B1, less effective because of significant losses of luminous flux, the coupler not being suited to the size of both the luminous source and the surface area of the connector.

Thus, there is a need to transmit a luminous beam, notably a colored beam emitted by a luminous source, to a bundle of optical fibers via a connector of cross section smaller than the surface area of the luminous source, while at the same time minimizing the losses of luminous flux and obtaining homogeneous illumination for each color at the entry to the connector.

### SUMMARY OF THE INVENTION

The invention offers a solution to the above-mentioned problems by making it possible to couple a luminous source having an area greater than the area of a connector connecting a bundle of optical fibers, while at the same time minimizing the losses of luminous flux between a luminous source and a bundle of optical fibers.

One aspect of the invention relates to an optical coupler having a longitudinal central axis X, said optical coupler comprising a first, a second and a third portion, and wherein:
said first portion has an envelope following the shape of an ellipsoid of revolution of axis X, truncated by a plane of section perpendicular to the longitudinal axis X, with a polygonal cross section, the area of said section increasing progressively along the longitudinal axis X, between an entry section and a first intermediate section;
said third portion has an envelope following the shape of a right prism, of polygonal cross section the area of which cross section is constant between a second intermediate section and a first exit section;
the area of the first intermediate section being greater than the area of the second intermediate section;
said second portion being a transition portion positioned between the first portion and the third portion, said second portion having an envelope with a cross section the area of which decreases progressively along the longitudinal axis X, said second portion comprising:
a first connecting section connecting to the first portion, the first connecting section being the first intermediate section,
a second connecting section connecting to the second portion, the second connecting section being the second intermediate section.

Thanks to the invention, it is possible to receive a luminous beam via the entry section that is larger than the first exit section, thereby making it possible to couple a luminous source the section of which is greater than the section of a connector of an optical-fibers assembly. The envelope of the first portion has a shape enabling the collection of a maximum amount of light, each light ray approaching the envelope of the portion with has an angle of incidence that allows total reflection thereof. The envelope of the second portion has a shape enabling the connecting of the first portion and the third portion and is designed to minimize the escape of luminous rays and therefore the loss of flux. The polygonal shape of the first and third sections makes it possible to break the propagation modes for the rays of different colors and obtain uniform illumination for each color at the exit from the coupler.

Besides the features that have just been outlined in the previous paragraph, the optical coupler according to one aspect of the invention may have one or more additional features from among the following, which are considered individually or in any technically feasible combination:
said optical coupler has a solid configuration;
said optical coupler comprises a fourth portion having an envelope of which the cross section is of constant area, along the longitudinal axis X, between the first exit section and a second exit section. Advantageously, the fourth portion allows the shape of the second exit section to be adapted so as to emit a luminous beam toward a light receiver, for example the optical-fibers bundle connector, the entry section of which is not the same shape as the first exit section of the third portion of the optical coupler.
the cross section of the envelope of the first portion and/or the cross section of the envelope of the third portion are respectively polygons of order n, n being a natural integer comprised between 4 and 10. Advantageously, a section in the form of a polygon of order n comprised between 4 and 10 enables the propagation of luminous rays of different colors to be made more homogeneous within the optical coupler, thereby breaking the propagation modes for each luminous ray.
the section of the envelope of the second portion is a polygon of order n. This feature allows a transition without discontinuity at the first connecting section and at the second connecting section.
n is equal to 6. Advantageously, the hexagonal shape of the section of the first portion and of the third portion is the optimum shape for making the propagation of luminous rays of different colors more homogeneous so as to obtain uniform illumination for each group of luminous rays of the same color.
said optical coupler is formed from a transparent optical material such as polycarbonate (PC), polymethyl methacrylate (PMMA), glass or silicone.
the envelope of the first portion has a first focus and a second focus, the first focus being located outside the optical coupler.

Another aspect of the invention relates to an optical illumination system comprising:
a luminous source;
an optical coupler according to the invention;
a bundle of optical fibers.

Besides the features that have just been outlined in the previous paragraph, the optical illumination system according to one aspect of the invention may have one or more additional features from among the following, which are considered individually or in any technically feasible combination:
the luminous source is a monochromatic, bichromatic or trichromatic light source.
the luminous source is placed at the conjugate focus of the first focus by the entry surface. Advantageously, this feature allows all the rays entering the coupler via the entry section to be focused at the second focus after having been totally or partially reflected.
the bundle of optical fibers comprises a plurality of optical fibers, each optical fiber of the plurality of optical fibers being made of polymethyl methacrylate. Polymethyl methacrylate is an advantageous material making it possible to obtain a collection of fine and flexible optical fibers that can be woven into a textile comprised in a trim panel for a vehicle interior compartment.

Another aspect of the invention relates to a trim panel for a vehicle interior compartment comprising the illumination system according to the invention.

The invention and its various applications will be better understood upon reading the following description and upon examining the figures accompanying it.

### BRIEF DESCRIPTION OF THE DRAWINGS

The figures are presented by way of indication and in no way limit the invention.

Unless stated otherwise, the same element appearing in different figures is provided with a single reference.

FIG. 1 is a diagram depicting an optical illumination system according to the invention.

FIG. 2 is a detailed diagram of an optical coupler according to the invention comprised in an optical illumination system according to the invention.

FIG. 3 is a diagram depicting the respective paths of two luminous rays emanating from a luminous source toward the first portion of the optical coupler according to the invention.

### DETAILED DESCRIPTION OF THE INVENTION

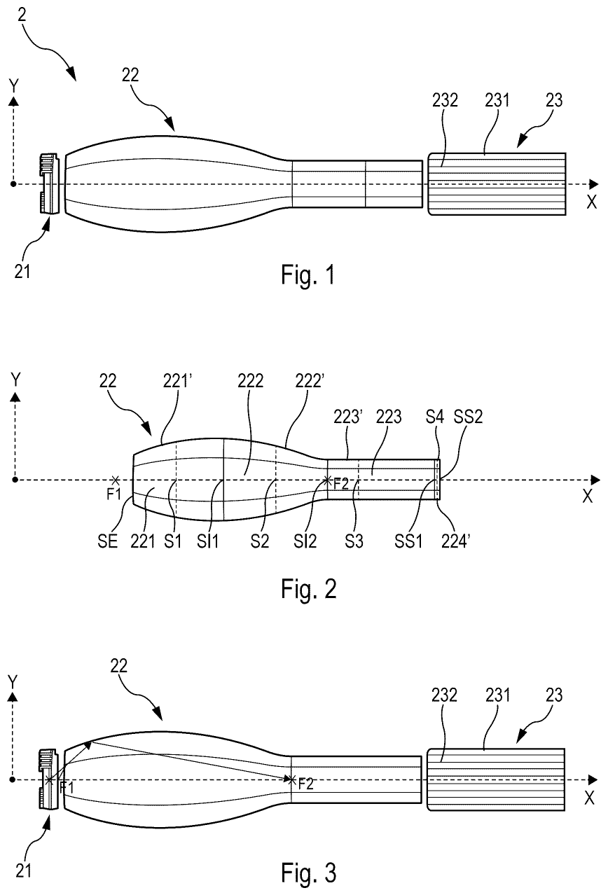

An optical illumination system 2 according to the invention is depicted schematically in FIG. 1.

The optical illumination system 2 comprises a luminous source 21, an optical coupler 22 according to the invention and a bundle 23 of optical fibers.

FIG. 2 depicts the optical coupler 22 in detail.

The optical coupler 22 has a longitudinal central axis X.

The optical coupler 22 comprises a first 221, a second 222 and a third 223 portion.

The optical coupler 22 may further comprise a fourth portion 224.

The first portion 221 has an envelope 221′ following the shape of an ellipsoid of revolution of axis X, truncated by a plane of section perpendicular to the longitudinal axis X.

Since the envelope 221′ of the first portion 221 is in the shape of an ellipsoid of revolution of longitudinal axis X, this envelope is defined by two foci situated on the longitudinal axis X: the envelope 221′ of the first portion 221 has a first focus F1 and a second focus F2. The envelope 221′ of the first portion 221 is truncated in such a way that the first focus F1 is located outside the first portion 221 and outside the optical coupler 22. The envelope 221′ of the first portion 221 is truncated in such a way that the second focus F2 is located outside the first portion 221 but inside the optical coupler 22.

The envelope 221′ of the first portion 221 has a regular polygonal cross section S1. The area of the cross section S1 of the envelope 221′ of the first portion increases progressively and continuously along the longitudinal axis X, between an entry section SE and a first intermediate section SI1. The area of the entry section SE is smaller than the area of the first intermediate section SI1. In other words, the envelope 221′ is formed of a continuous succession of increasing polygonal sections.

As a preference, the area of the entry section SE completely covers a square surface of an area greater than or equal to 9 mm².

For example, the area of the polygonal entry section SE completely covers a square surface of an area equal to 16 mm².

For example, the diameter of the circle inscribed inside the polygonal entry section SE is greater than or equal to 3 mm.

For example, the diameter of the circle inscribed inside the entry section SE is equal to 4 mm.

For example, the diameter of the circle inscribed inside the polygonal first intermediate section SI1 is comprised between 6 mm and 10 mm.

As a preference, the diameter of the circle inscribed inside the polygonal first intermediate section SI1 is equal to 6.698 mm.

Thus, the envelope 221′ of the first portion 221 is bounded at its ends by the entry section SE and by the first intermediate section SI1.

The entry section SE is adapted to receive a beam of light.

As a preference, the envelope 221′ of the first portion 221 is designed so that the focus F1 is situated at a predetermined distance D, along the longitudinal axis X, from the entry section SE.

The section S1 of the envelope of the first portion 221 is a convex regular polygon of order n, the number n being a natural integer preferably comprised between 4 and 10. The order of a polygon is the number of its edges and/or the number of its vertices.

Thus, the cross section S1 of the envelope of the first portion 221 may be a quadrilateral, for example a square, a pentagon, a hexagon, a heptagon, an octagon, a nonagon or a decagon.

As a preference, the cross section S1 of the envelope of the first portion 221 is a polygon of order 6 and is therefore a hexagon.

The third portion 223 has an envelope 223′ following the shape of a right prism of which the central axis is the longitudinal axis X. A right prism is a geometric solid bounded by two polygons, the two polygons being connected to one another by parallelograms.

The envelope 223′ of the third portion 223 has a polygonal cross section S3 that is continuous and constant between a second intermediate section SI2 and a first exit section SS1. Thus, the envelope 223′ of the third portion 223 is formed of a continuous succession of constant polygonal sections.

According to a first embodiment, the first exit section SS1 is adapted to emit a beam of light.

Thus, the envelope 223′ of the third portion 223 is delimited at its ends by the second intermediate section SI2 and the first exit section SS1.

Because the envelope 223′ of the third portion follows the form of a right prism, the cross section S3 of the envelope of the third portion 223 is thus polygonal.

According to a preferred embodiment, the cross section S3 of the envelope 223′ of the third portion 223 is a polygon of order n, the number n being defined above. Thus, the cross section S3 of the envelope 223′ of the third portion 223 may be a quadrilateral, for example a square or a rectangle, a pentagon, a hexagon, a heptagon, an octagon, a nonagon or a decagon. Thus, the envelope 223′ of the third portion 223 comprises n planar faces.

According to one embodiment, the cross section S3 of the envelope 223′ of the third portion 223 is a polygon of order k, k being a natural integer different than n. k is preferably comprised between 4 and 10.

As a preference, the section S3 of the envelope of the third portion 223 is a polygon of order 6 and is therefore a hexagon.

As a preference, the area of the polygonal first exit section SS1 completely covers a circular surface of an area less than or equal to 9 mm².

As a preference, the diameter of the circle inscribed inside the polygonal first exit section SS1 is less than or equal to 3 mm.

For example, the diameter of the circle inscribed inside the polygonal first exit section SS1 is equal to 2 mm.

The second portion 222 is a transition portion positioned between the first portion 221 and the third portion 223.

The second portion 222 is connected to the first portion 221 via a first connecting section, the first connecting section being the first intermediate section SI1. Thus, the first intermediate section SI1 is common to the first portion 221 and to the second portion 222 of which it forms a first end section.

The second portion 222 is connected to the third portion 233 via a second connecting section, the second connecting section being the second intermediate section SI2. Thus, the second intermediate section SI2 is common to the second portion 222, of which it forms a second end section, and to the third portion 223.

Thus, the second portion 222 is bounded at its ends by the first intermediate section SI1 and the second intermediate section SI2.

The second portion 222 comprises an envelope 222′ the area of the section S2 of which decreases along the longitudinal axis X, the section S2 of the envelope 222′ of the second portion 222 decreasing continuously.

According to the embodiment in which the natural integer n is equal to the natural integer k, the cross section S2 of the envelope 222′ of the second portion 222 is preferably a polygon of order n and the envelope 222′ of the second portion 222 is formed by a continuous succession of increasing polygonal sections.

According to an embodiment in which the optical coupler 22 comprises the fourth portion 224, the fourth portion 224 has an envelope 224′ of which the cross section S4 is constant and continuous along the longitudinal axis X, between the first exit section SS1, which forms a first end section of the fourth portion 224, and a second exit section SS2, which forms a second end of the fourth portion 224, adapted to emit a beam of light.

Thus, the first exit section SS1 is common to the third portion 223 and to the fourth portion 224. As a preference, the second exit section SS2 is circular. As a preference, the diameter of the second exit section SS2 is less than 3 mm, and for example comprised between 2 mm and 3 mm. As a preference, the area of the first exit section SS1 and the area of the second exit section SS2 are identical.

Thus, the area of the entry section SE is greater than the area of the first exit section SS1.

Thus, the area of the entry section SE is greater than the area of the second exit section SS2.

The optical coupler 22 exhibits no discontinuity between the first portion 221 and the second portion 222.

The optical coupler 22 exhibits no discontinuity between the second portion 222 and the third portion 223.

The optical coupler 22 exhibits no discontinuity between the third portion 223 and the fourth portion 224.

The optical coupler 22 may be formed from at least one material and the material may be a transparent optical material such as PC (polycarbonate), PMMA (polymethyl methacrylate), for example extruded PMMA, glass or silicone, or any other transparent optical material.

The optical coupler 22 may be formed of a reflective metal for example.

According to one preferred embodiment in which the optical coupler 22 is formed from a transparent optical material, said optical coupler 22 is preferably of solid configuration, and thus has no extrusion.

According to one embodiment in which the optical coupler 22 is formed from a reflective metal, the optical coupler 22 is of hollow configuration.

The material that forms the optical coupler 22 has an index n_{c}, it being possible for the index n_{c} to vary with the wavelength.

When the optical coupler 22 is formed from PMMA, the index of the optical coupler 22 may take the value n_{c}=1.49.

When the optical coupler 22 is formed from PMMA, the index of the optical coupler 22 may take the value n_{c}=1.49.

When the optical coupler 22 is formed from PC, the index of the optical coupler 22 may take the value n_{c}=1.586.

When the optical coupler 22 is formed from glass, the index of the optical coupler 22 may take the value n_{c}=1.5.

Thus, the entry section SE is a diopter.

According to a first embodiment in which the optical coupler 22 comprises three portions, the first exit section SS1 is a diopter.

According to a second embodiment in which the optical coupler 22 comprises the fourth portion 224, the second exit section SS2 is a diopter.

The total length of the optical coupler 22 along the longitudinal axis X is, for example, equal to 25 mm. As a preference, the lengths of the first portion 221, of the second portion 222 and of the third portion 223, along the longitudinal axis X, are equal. As a preference, the length of the fourth portion 224 is very much less than the length of the first portion 221, the second portion 222 and the third portion 223.

The optical coupler 22 may receive, via the entry section SE, a luminous beam emitted by the luminous source 21.

A luminous beam is a collection of luminous rays emanating from the one same luminous source. The collection of rays propagates preferably in all the directions of the solid angle equal to 2π steradians.

According to one embodiment, the luminous source 21 may be monochromatic or polychromatic.

A monochromatic luminous source 21 emits a luminous beam of a single wavelength.

The polychromatic luminous source 21 may emit a luminous beam the electromagnetic spectrum of which is spread across the visible domain, it being possible for example for the luminous source 21 to be a source of white light.

The polychromatic luminous source 21 may in particular be a trichromatic light source emitting a luminous beam resulting from a superposition of three luminous beams with three wavelengths respectively, each wavelength corresponding to a different primary color; it being possible for the intensity of each luminous beam to be different. The three primary colors are red, green and blue.

According to one embodiment, the luminous source 21 may be a laser.

According to one embodiment, the luminous source 21 comprises at least one monochromatic LED (light-emitting diode). A monochromatic LED produces a monochromatic luminous beam. The monochromatic luminous beam may be red, green or blue in color for example. The intensity of the luminous radiation emitted by each monochromatic LED may be modified.

According to one embodiment, the luminous source 21 preferably comprises an RGB (red green blue) LED known as an RGB LED. An RGB LED is a package made up of three monochromatic LEDs, the three LEDs respectively emitting monochromatic luminous beams respectively Red, Green and Blue in color. The package may be clear.

According to the preceding embodiment, when the package is clear, the RGB LED simultaneously emits three distinct luminous radiations respectively red, green and blue in color.

According to the preceding embodiment, when the package is a diffusing package, the RGB LED emits a luminous beam the color of which corresponds to the synthesis of the three colors: red, green and blue.

According to one embodiment, the luminous source 21 is placed in the plane perpendicular to the longitudinal axis X and comprising the conjugate focus F′1 of the first focus F1 by the entry section SE. The conjugate focus F′1 is situated on the longitudinal axis X. In other words, the luminous source 21 is placed on the conjugate focus F′1 such that the image of the luminous source 21 by the entry surface is situated at the first focus F1. The conjugate focus F′1 is situated at a distance D′ from the entry section SE. The conjugate focus F′1 can be found using the Descartes conjugate equation.

As a preference, the luminous source 21 is centered on the longitudinal axis X.

Thus, according to the preceding embodiment, the luminous source 21 is situated at a distance D′ from the entry section SE.

According to the preceding embodiment, the distance D is selected such that the distance D′ is, for preference, greater than or equal to 0.5 mm. For example, the distance D′ may be equal to 1 mm. A distance D′ greater than or equal to 0.5 mm limits the risk of damage to the entry section SE by the increased heat occasioned by receipt of the luminous beam emitted by the luminous source 23. A distance D′ greater than or equal to 0.5 mm also makes it possible to obtain a tolerance on the spacing between the luminous source 21 and the entry section SE so that the luminous source 21 is never touching the optical coupler 22.

According to the preceding embodiment, in which the luminous source 21 emits a monochromatic or polychromatic luminous beam toward the entry section SE, the luminous rays of the luminous beam entering the entry section SE are totally reflected by the envelope 221′ of the first portion 221 and are partially reflected by the envelope of the second portion 222, depending on their respective angle of incidence and the index of the material of the optical coupler 22.

Let nₐᵢᵣ and θ be the angle of incidence of a luminous ray of a luminous beam emitted by the luminous source 21. The ellipsoidal shape of the envelope of the first portion 221 is designed such that each luminous ray incident on the envelope of the first portion 221 is totally reflected toward the focus F2. Thus, according to the Descartes equation, each luminous ray incident on the envelope of the first portion 221 has an angle of incidence that satisfies the following condition:

Sin(θ)>n−nₐᵢᵣ/n_{c}, the sine of the angle of the incident luminous ray is greater than the ratio between the index of air nₐᵢᵣ and the index of the coupler n_{c}.

According to the preceding embodiment, in which the luminous source 21 emits a monochromatic or polychromatic luminous beam toward the entry section SE, the envelope 222′ of the second portion 222 is designed to minimize the escape of the luminous rays incident on the envelope 222′ of the second portion 222, so as to minimize losses affecting the brightness and intensity of the luminous rays.

Because the luminous source 21 is situated at the conjugate focus F′1, each luminous ray totally or partially reflected by the envelope 221′ of the first portion 221 or the envelope 222′ of the second portion 222 is focused at the focus F2, contained in the third portion 223.

FIG. 3 depicts the path of two luminous rays emitted by the luminous source 21 and reflected by the envelope 221′ of the first portion 221 toward the focus F2.

It is possible that certain luminous rays, of wavelength λ, may be focused at the focus F2 λ, situated on the longitudinal axis X which is separated from the focus F2 by less than one millimeter, rather than directly at the focus F2, as a result of chromatic aberration.

According to one embodiment in which the luminous source 21 is an RGB LED emitting a luminous beam containing red luminous rays, green luminous rays and blue luminous rays toward the entry surface SE, all the reflected luminous rays are focused at the focus F2 and then propagate respectively in the third portion 223, reflecting off the n planar faces of the envelope 223′ of the third portion 223. Advantageously, the polygonal-shape section 23 of the third portion 223 is able to break the propagation modes of each red luminous ray, each green luminous ray and each blue luminous ray as a result of the multiple reflections off each of the n faces of the third portion 223 and obtain a uniform distribution of the luminous intensity and an optimal and homogeneous mixing of colors at the exit of the third portion 223, at the third intermediate section SI3.

According to the preceding embodiment, in which the optical coupler 22 comprises the fourth portion 224, the fourth portion 224 is able to conduct luminous rays of uniform intensity and of homogeneous color from the third intermediate section as far as the optical-fibers bundle 23.

The bundle 23 of optical fibers (or optical-fibers bundle 23) comprises a connector 231 and at least one optical fiber 232, preferably a plurality of optical fibers, the plurality of optical fibers being twisted into the connector 213. As a preference, the optical fibers of the plurality of optical fibers are identical.

The connector 231 may have a circular cross section.

As a preference, the optical-fibers bundle 23 has a linear configuration. In a linear configuration, all the optical fibers of the plurality of optical fibers are parallel and comprised in the one same plane.

In the embodiment in which the optical coupler 22 comprises the fourth portion 224 and in which the second exit section SS2 is circular, the connector 213 has a transverse diameter equal to the diameter of the second exit section SS2 of the fourth portion 224 of the optical coupler 22.

Each optical fiber 232 of the optical-fibers bundle 23 is a multimode fiber.

Each optical fiber 232 of the optical-fibers bundle 23 preferably has an outside diameter equal for example to 0.5 mm or to 0.25 mm.

According to one embodiment in which the plurality of optical fibers of the optical-fibers bundle 23 are woven directly into a decorative fabric, it is preferable to use optical fibers with a respective diameter equal to 0.25 mm, as this allows for a finer weave and finer pattern.

According to one embodiment in which the plurality of optical fibers of the optical-fibers bundle 23 are woven directly into a technical fabric, covered with a decorative material, it is preferable to use optical fibers with a respective diameter equal to 0.5 mm.

Each optical fiber 232 of the optical-fibers bundle 23 is preferably formed for example from glass or preferably plastic, for example PMMA (polymethyl methacrylate).

According to one embodiment, each optical fiber 232 of the optical-fibers bundle 23 is unsheathed.

One embodiment, each optical fiber 232 of the optical-fibers bundle 23 comprises a sheath made from a fluorinated polymer and a core made of PMMA.

Each optical fiber 232 of the optical-fibers bundle 23 is adapted to convey luminous rays.

According to one embodiment, in which the optical coupler 22 is formed of PC, the connector 231 is bonded to the optical coupler 22 via the exit section SS, using an optical-quality transparent adhesive of the OCA (Optical Clear Adhesive) type.

According to one embodiment, in which the optical coupler 22 comprises the fourth portion 224, the connector 231 is situated at a distance Dc away from the second exit section SS2 of the fourth portion of the optical coupler 22.

The optical illumination system 2 may be comprised in a trim panel for a vehicle interior compartment.

A number of simulations were run in order to evaluate the efficiency of the optical coupler 22 according to the embodiment in which the coupler 22 comprises the fourth portion, the efficiency being defined as the ratio between the amount of luminous flux (in Lumens) at the second exit section SS2 for the {luminous source 21+optical coupler 22} assembly, and the amount of luminous flux (in Lumens, denoted Lm) emitted by the luminous source 21. In the context of the simulations, the luminous source 21 is an RGB LED. The efficiency is measured for an optical coupler 22 formed from PC and for an optical coupler 22 formed from PMMA. Several diameters of section for the second exit section SS2 were simulated.

The following simulations were run for an embodiment in which the optical coupler 22 is bonded to the fiber twist by means of a transparent adhesive, via the second exit SS2, to the optical-fibers bundle 23 using an optical-quality transparent adhesive:

TABLE 1

| | Diameter of | PMMA | | PC | |
|---|---|---|---|---|---|
| | second exit | Exit | | Exit | |
| | section (mm) | flux (Lm) | Efficiency | flux (Lm) | Efficiency |
| LED | — | 4.39 | — | 4.9 | — |
| LED + | 3.3 | 3.25 | 73.60% | 3.29 | 74.90% |
| optical | 2.7 | 2.56 | 59.10% | 2.7 | 61.50% |
| coupler | 2.2 | 1.76 | 40.20% | 1.92 | 43.70% |

The selected LED emits a luminous beam the flux of which is equal to 4.39 Lm. According to the foregoing simulations, the luminous flux at the exit of the {LED+optical coupler 22} assembly, with the optical coupler 22 being formed from PC, yields a greater efficiency compared with an {LED+optical coupler 22} assembly, with the optical coupler 22 being formed from PMMA. In this embodiment, the efficiency is better when the coupler is formed from PC because the refractive index of PC is higher than the refractive index of PMMA.

The following simulations were run for an embodiment in which the coupler is not bonded to the optical-fibers bundle:

TABLE 2

| | Diameter of | PMMA | | PC | |
|---|---|---|---|---|---|
| | section SS | Exit | | Exit | |
| | (mm) | flux (Lm) | Efficiency | flux (Lm) | Efficiency |
| LED | — | 4.39 | — | 4.39 | — |
| LED + | 3.3 | 2.455766 | 55.94% | 2.400452 | 54.68% |
| optical | 2.7 | 1.971988 | 44.92% | 1.97111 | 44.90% |
| coupler | 2.2 | 1.341145 | 30.55% | 1.40041 | 31.90% |

Thus, when the optical coupler 22 is not bonded to the optical-fibers bundle 23, the efficiency decreases by 14% for an optical coupler 22 formed from PMMA and decreases by 17% for an optical coupler 22 formed from PC.

What is claimed is:

1. An optical coupler having a longitudinal central axis, the optical coupler comprising a first, a second and a third portion, and wherein:
the first portion has an envelope following the shape of an ellipsoid of revolution of axis, truncated by a plane of section perpendicular to the longitudinal axis, with a polygonal cross section, the area of the cross section increasing progressively along the longitudinal axis, between an entry section and a first intermediate section;
the third portion has an envelope following the shape of a right prism, of polygonal cross section the area of which cross section is constant between a second intermediate section and a first exit section,
with the area of the first intermediate section being greater than the area of the second intermediate section,
the second portion being a transition portion positioned between the first portion and the third portion, the second portion having an envelope with a cross section the area of which decreases progressively along the longitudinal axis, the second portion including:
a first connecting section connecting to the first portion, the first connecting section being the first intermediate section,
a second connecting section connecting to the second portion, the second connecting section being the second intermediate section.

2. The optical coupler as claimed in claim 1, wherein the optical coupler has a solid configuration.

3. The optical coupler as claimed in claim 1, further comprising a fourth portion having an envelope of which the cross section is of constant area, along the longitudinal axis, between the first exit section and a second exit section.

4. The optical coupler as claimed in claim 1, wherein in the cross section of the envelope of the first portion and/or the cross section of the envelope of the third portion are respectively polygons of order n, n being a natural integer comprised between 4 and 10.

5. The optical coupler as claimed in claim 4, wherein n is equal to 6.

6. The optical coupler as claimed in claim 1, wherein the optical coupler is formed from the following material: polycarbonate, polymethyl methacrylate, glass or silicone.

7. The optical coupler as claimed in claim 1, wherein the envelope of the first portion has a first focus and a second focus, the first focus being located outside the optical coupler.

8. An optical illumination system comprising:
a luminous source;
an optical coupler with an entry surface, the optical coupler including a first, a second and a third portion, with the first portion having an envelope following the shape of an ellipsoid of revolution of axis, truncated by a plane of section perpendicular to the longitudinal axis, with a polygonal cross section, the area of the cross section increasing progressively along the longitudinal axis, between an entry section and a first intermediate section, with the third portion having an envelope following the shape of a right prism, of polygonal cross section the area of the first intermediate section being greater than the area of the second intermediate section, and the second portion being a transition portion positioned between the first portion and the third portion, the second portion having an envelope with a cross section the area of which decreases progressively along the longitudinal axis, the second portion including a first connecting section connecting to the first portion, the first connecting section being the first intermediate section and a second connecting section connecting to the second portion, the second connecting section being the second intermediate section; and
a bundle of optical fibers.

9. The optical illumination system as claimed in claim 8, wherein the luminous source is placed at a conjugate focus of a first focus by the entry surface.

10. The optical illumination system as claimed in claim 8, wherein the bundle of optical fibers includes a plurality of optical fibers, each optical fiber of the plurality of optical fibers being made of polymethyl methacrylate.
